(19) United States
(12) Patent Application Publication
(10) Pub. No.: US 2007/0250775 A1
(43) Pub. Date: Oct. 25, 2007

(54) Methods, systems, and computer program products for providing hyperlinked video

(76) Inventors: Peter Joseph Marsico, Chapel Hill, NC (US); Cory Andrew Grant, Apex, NC (US)

Correspondence Address: Peter Joseph Marsico, 1415 Preston Spring Lane, Chapel Hill, NC, 27516, US

(21) Appl. No.: 11/786,546

(22) Filed: Apr. 12, 2007

Related U.S. Application Data
(60) Provisional application No. 60/793,152, filed on Apr. 19, 2006.

(51) Int. Cl. G06F 3/00

(52) U.S. Cl. 715/716

(57) ABSTRACT

Methods, systems and computer program products for providing hyperlinked video are disclosed. According to one aspect of the present invention, when a user pauses playback of a video on a video frame, the hypervideo media player is adapted to query a hyperdata function and request hyperlinked object information associated with the paused video frame. The hyperdata function is adapted to respond to the query with hyperlinked object information for the paused video frame. The hypervideo media player receives the hyperlinked object information and updates the paused video frame to display the hyperlinked object information. When the user selects a hyperlinked object, the hypervideo media player is adapted to perform the hyperlink action associated with the selected hyperlinked object. When the user resumes playback of the video, the hyperlinked object information may be discarded or cached for later viewing.

### RELATED APPLICATIONS

This application claims the benefit of U.S. Provisional Patent Application Ser. No. 60/793,152, filed Apr. 19, 2006, the disclosure of which is incorporated herein by reference in its entirety.

### TECHNICAL FIELD

The subject matter described herein relates to methods and systems for providing and displaying hyperlinked video media to a user.

### BACKGROUND OF THE INVENTION

Prior hypervideo delivery systems rely on the creation and presentation of a video stream that includes a “parallel” or synchronous stream of hyperlink information that is integrated with the video stream before or during playback to a user. Such techniques enable hyperlinked objects to be constantly visible/identifiable during playback of the video stream. To provide such a continuum, hyperlink information must either be integrated within the video stream prior to playback, or the hyperlink information must be continuously provided to a hypervideo viewer/media player, where integration effectively occurs at the time of playback/presentation to the user. In either case, hyperlinked objects are constantly visible to and accessible by the user during playback of the video stream. These constantly present hyperlinked video links may be activated automatically during playback of the video stream or may be activated by a user that selects or “clicks” the hyperlinked object.

However, such hypervideo delivery techniques suffer from several significant drawbacks. One drawback is bandwidth consumption. The constant streaming of hyperlinked object information, in parallel with the video stream, consumes bandwidth in an inefficient manner. That is, bandwidth is constantly required to provide hyperlinked object information regardless of whether the user happens to be currently interested in browsing/interacting with hyperlinked objects. Since it is unlikely that a user would want to interact with hyperlinked objects on every frame of a video stream, it is inefficient to waste bandwidth continuously updating a hypervideo viewer/media player with hyperlink information for every (or nearly every) video frame in a video stream. Such inefficient use of bandwidth may become especially relevant/problematic in wireless networking environments where bandwidth resources are limited.

Another drawback is that multicasting of hypervideo (e.g., video stream and a synchronized hyperdata stream) to many users simultaneously does not permit targeted or customized hyperlink information to be provided to individual hypervideo viewers, since they are all viewing the same multicast, hypervideo feed.

In light of these shortcomings in current hypervideo delivery technology, there exists a need for improved methods, systems, and computer program products for providing hypervideo to a user.

### SUMMARY OF THE INVENTION

According to one aspect, the present invention includes a hypervideo viewer or hypervideo-capable media player that is adapted to receive and play a video stream, such as an MPEG, AVI, Quicktime, or other formatted video stream. The video stream may be sourced from a remote server located in a data network, or the video stream may be sourced from a local source, such as a DVD disc, hard disk, flash RAM on a user terminal (e.g., personal computer, mobile communication device, etc.). When the user pauses playback of the video stream on a video frame, the hypervideo media player is adapted to query a hyperdata function and request hyperlinked object information associated with the paused video frame. The hyperdata function is adapted to respond to the query with hyperlinked object information for the paused video frame. The hypervideo media player receives the hyperlinked object information and updates the paused video frame to display the hyperlinked object information. When the user selects a hyperlinked object, the hypervideo media player is adapted to perform the hyperlink action associated with the selected hyperlinked object. When the user resumes playback of the video stream, the hyperlinked object information may be discarded or cached for later viewing.

The hyperdata function may reside on a server in a data network (e.g., Internet protocol network, World Wide Web, wireless network, wide area network, local area network), or the hyperdata function may be integrated with the hypervideo media player and/or co-located on the same user terminal as the hypervideo media player.

The subject matter described herein providing hypervideo may be implemented using a computer program product comprising computer executable instructions embodied in a computer readable medium. Exemplary computer readable media suitable for implementing the subject matter described herein include disk memory devices, programmable logic devices, application specific integrated circuits, and downloadable electrical signals. In addition, a computer readable medium that implements the subject matter described herein may be located on a single device or computing platform distributed across multiple physical devices and/or computing platforms.

### BRIEF DESCRIPTION OF THE DRAWINGS

Preferred embodiments of the subject matter described herein will now be explained with reference to the accompanying drawings of which:

FIG. 1 is an exemplary network message flow diagram illustrating the querying of a hyperdata function by a hypervideo viewer via an Internet protocol (IP) network;

FIG. 2 is flow chart diagram that illustrates exemplary operation of one embodiment of a hypervideo system of the present invention;

FIG. 3 is a block system diagram that illustrates an exemplary hyperdata function;

FIG. 4 is an exemplary network diagram illustrating a hyperdata function that is adapted to access a personal information database;

FIG. 5 is a block system diagram illustrating a hyperdata function that is adapted to access a hyperlink data/content database;

FIG. 6 is flow chart diagram that illustrates exemplary operation of an embodiment of a hypervideo system of the present invention, which includes a hyperdata function that is adapted to access a personal information database;

FIG. 7 is a block system diagram that illustrates an exemplary hypervideo viewer;

FIG. 8 is a flow chart diagram that illustrates a first hyperlink caching aspect of one embodiment of the present invention; and

FIG. 9 is a flow chart diagram that illustrates a second hyperlink caching aspect of one embodiment of the present invention.

### DETAILED DESCRIPTION OF THE INVENTION

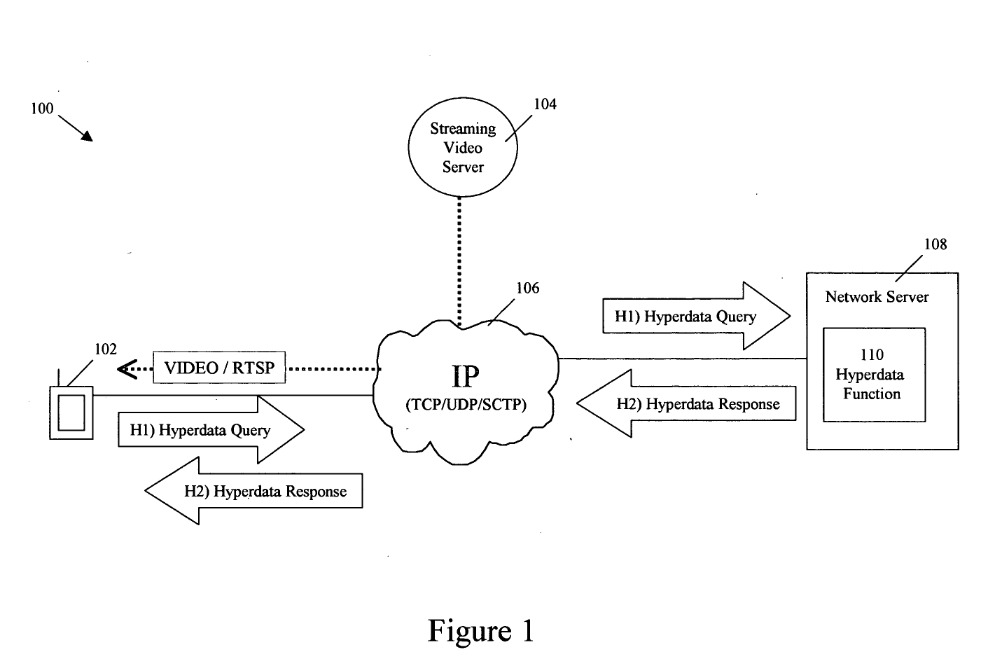

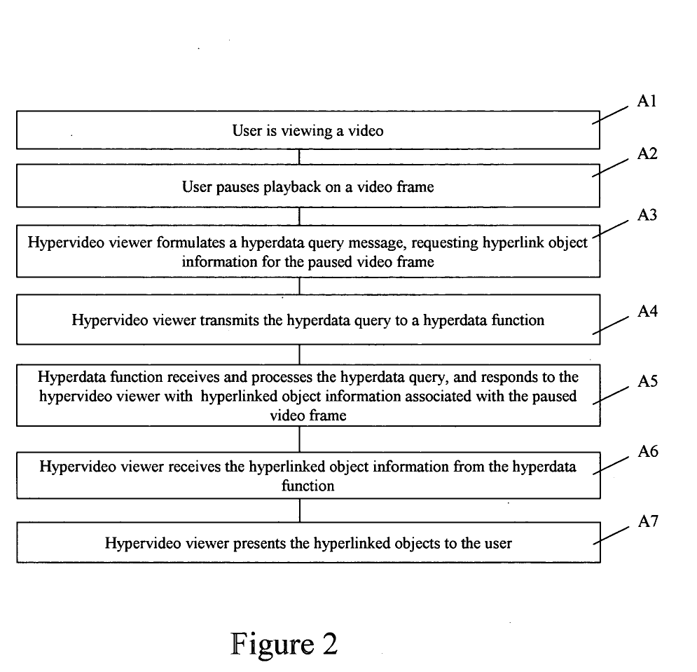

Disclosed are systems and methods for providing hyperlinked video to a user. According to one aspect a video stream is viewed by a user via a hypervideo video viewer of the present invention. As used herein, the term video stream may be video streamed from a network server using a streaming protocol, such as ASF, ASX, MOV, and WMV via Real Time Streaming Protocol (RTSP) or Synchronized Multimedia Integration Language (SMIL), or a video stream generated during the playing of a video file, such as an MPEG, AVI, Quicktime® formatted multimedia file. An exemplary embodiment of a hypervideo delivery system of the present invention is illustrated in FIG. 1, and an associated process flow diagram is illustrated in FIG. 2. A network environment 100 includes a mobile hypervideo player/viewer 102 for playing a video stream and, requesting and presenting hyperdata information, a network video server 104 for providing streaming video to viewer 102, an Internet protocol (IP) network 106 for transporting video and hyperdata information, a network hypervideo server 108 and associated hyperdata function 110 for providing hyperdata information. In this example, mobile terminal 102 contacts video server 104 and begins playback of a video stream provided by the video server (step A1). When playback of the video stream is paused on mobile hypervideo player 102 (step A2), the hypervideo viewer is adapted to generate and transmit a query message (H1) to the hyperdata function requesting video hyperlink object information associated with the video frame on which the viewer is paused (steps A3 and A4). The hyperdata function 110 returns via response message H2 the requested video hyperlink object information to the hypervideo viewer (steps A5 and A6). The returned video hyperlink object information may include hyperlink information that is associated with an object that is defined in the frame of video on which the viewer is paused. In one embodiment, returned video hyperlink object information may include information that identifies a hyperlinked object within the paused video frame. Exemplary information that identifies a hyperlinked object includes information that defines an area or shape on the paused video frame that is associated with a hyperlinked object, and/or information that defines a positional coordinate on the paused video frame that is associated with the location of a hyperlinked object. That is, the hyperlink object information returned by the hyperdata function provides the requesting hypervideo viewer with a list of hyperlink objects (e.g., video frame positional coordinates) that are defined on the paused video frame and various hyperlink object attributes (e.g., URL) associated with each object. This hyperlink object definition and associated hyperlink object attribute information are referred to collectively herein as hyperlink object information.

In the case where the hyperlinked object information returned by the hyperdata function defines an area on the paused video frame that is associated with a hyperlinked object, the hypervideo viewer may use this information to highlight some or all of the hyperlinked object on the paused video frame, so as to indicate to the user that the object is hyperlinked or “clickable”. In the case where the hyperlinked object information returned by the hyperdata function defines a positional coordinate on the paused video frame, the hypervideo viewer may use this information to place a hyperlink marker (e.g., a flashing dot, a hyperlink graphic icon, etc.), so as to indicate to the user that the object is hyperlinked or “clickable”.

Hyperlink object attribute information associated with the hyperlinked object that is returned by the hyperdata function in response to a hyperdata query may also include hyperlink information such as a Uniform Resource Locator (URL), a Uniform Resource Identifier (URI), an email address, a telephone number, an audio file or audio stream, a video file or video stream, a graphic image (e.g., JPEG file), a text message, or other hyperlinkable information. Once a hyperlinked object is displayed to the user (step A7), the user may “click” on the hyperlinked object and activate the hyperlink. For example, a user may click on a hyperlinked object that includes an associated URL, which in turn launches a WEB browser that attempts to access the URL. In another example, a user may click on a hyperlinked object that includes an associated email address identifier, which in turn launches an email client that formulates an email message addressed to the email address identifier. In yet another example, a user may click on a hyperlinked object that includes an associated URI, which in turn launches a voice-over-IP communications client that attempts to establish a voice call to the URI address. In yet another example, a user may click on a hyperlinked object that includes an associated streaming video link, which in turn launches another video viewer instance and plays the video stream.

Additional descriptive information or hyperlink object attributes (e.g., text, color, size, lifespan) associated with a hyperlinked object may also be returned by the hyperdata function in response to a received hyperdata query. With regard to hyperlinked object lifespan, it will be appreciated that a display time duration or lifetime attribute may be associated with a hyperlinked object that is returned by the hyperdata function, where the lifespan attribute determines the length of time that the associated hyperlinked object will be displayed to the user once it is initially presented. For example, a hyperlinked object that is assigned a lifespan of 10 seconds will be displayed to the user for 10 seconds after the video stream is paused, and the object is initially presented to the user.

### Hyperdata Function

As such, it will be appreciated that the hyperdata function maintains information which (1) defines a hyperlinked object within a video frame, (2) describes the position or location of the hyperlinked object within the video frame, (3) associates hyperlink object attribute information with the object. Hyperdata function is adapted to return at least some of this hyperlinked object information in response to a hyperdata query received from a hypervideo viewer.

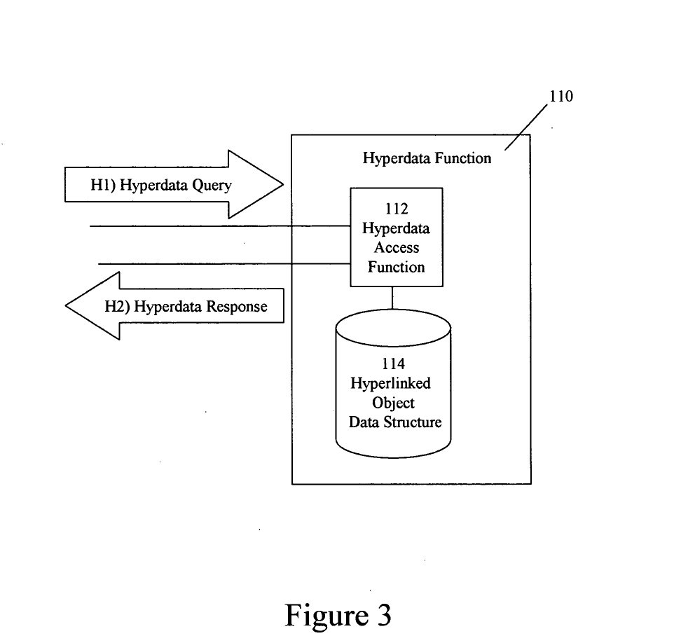

A block system diagram of an exemplary hyperdata function 110 is illustrated in FIG. 3. The exemplary hyperdata function includes a hyperdata access function 112 is adapted to receive a query message (H1) requesting hyperlinked object information from a hypervideo viewer. The hyperdata function is adapted to use information contained in the received query to retrieve relevant hyperlinked object information from a hyperlinked object data structure 114. In one embodiment, the hyperdata function may use personal information along with video frame information contained in the received query to retrieve relevant hyperlinked object information from a hyperlinked object database. In another embodiment, personal information may be obtained from the personal information database which then in turn is used to select/determine which hyperlinked objects and associated hyperlink object attribute information is returned to the requesting user. In yet another embodiment, the hyperdata function may use information contained in the received query to access a remote hyperlink data/content server to obtain information and/or content (e.g., music, video, text, image, etc.) that is to be returned to the requesting user. In any event, hyperdata access function is adapted to generate a response to the received query, which provides the requested hyperlinked object information. The response message (H2) is communicated to the requesting hypervideo viewer.

A hyperdata function is adapted to associate one or more media attributes with a hyperlinked object, where exemplary media attributes may include, but are not limited to, video program identifier (e.g., movie name, TV program identifier, etc.), video image frame, video image frame range, video media codec/format information, video media display resolution, media player identification information (e.g., Microsoft Windows® Media Player version 15.x), media player capability information.

TABLE 1
Media Attribute-to-Hyperlinked Object Associations

| | | | | 1920 × 1080 |
|---|---|---|---|---|
| | | | | Screen |
| | | | | Position |
| | Frame ID | Frame ID | | Coordinate |
| Video ID | Range Start | Range Stop | Object ID | (x, y) |
| Toy Story | 000134234 | 000135137 | TS1021 | 100, 200 |
| Toy Story | 000134234 | 000135137 | TS1022 | 400, 150 |
| Toy Story | 000135138 | 000135453 | TS1021 | 150, 200 |
| Toy Story | 000135138 | 000135453 | TS1023 | 140, 300 |

Table 1 illustrates exemplary media attribute-to-hyperlinked object associations that may be maintained by the hyperdata function. It will be appreciated that data structures other than that illustrated in Table 1 may be used in accordance with embodiments of the present invention. In the example shown, hyperlinked objects are associated with video frames of the Walt Disney® video Toy Story®. Each entry in Table 1 includes an identifier that identifies the video program (e.g., Toy Story®), a video frame start and stop range, an identifier that is associated with a hyperlinked object, and screen coordinate positional information.

The video frame start and stop range information specifies the range of video frames for which the associated hyperlinked object is present/valid. In an alternate embodiment, hyperlinked object associations may be made on a video frame-by-video frame basis, as opposed to a range, such as is illustrated in Table 1. In any event, video frame identification information may include a frame identifier, such as a sequential frame number (e.g., frame number=234,233), or a time-based identifier (e.g., 01:23.37.05, hh:mm.ss.60^{th} of a sec). The hyperlinked object identifier may be a numeric value (e.g., decimal, binary, hexadecimal, etc.), text value, or a combination. The first entry in sample Table 1 associates hyperlinked object “TS1021” with video frames within the range of “000134234” and “000135137” of the video program “Toy Story®”.

In the example illustrated in Table 1, screen coordinate positional information for each hyperlinked object is maintained with respect to a 1920×1080 resolution. Such hyperlink object positional information is referred to herein as a hyperlink object attribute. If, for instance, a viewer requesting hyperlinked object positional information is viewing the video in lower resolution media player, the hyperdata function may translate/scale the positional coordinates of the hyperlinked object prior to responding to the requesting viewer, or the hyperdata function may simply return the 1920×1080 resolution-based positional coordinates and allow the requesting media player to translate the coordinates based on the requesting media player's playback resolution.

According to one embodiment of the present invention, a hyperdata function may associate one or more personal information attributes with a hyperlinked object, such that the hyperlinked object information returned in response to a received hyperdata query is based, at least in part, on viewer personal information attribute information provided in the received hyperdata query. Exemplary personal information attributes include, but are not limited to, name, street address, email address information, instant message address information, network IP address information, location information (e.g., global positioning system coordinate information), telephone number, international mobile station identifier (IMSI) information, uniform resource identifier (URI) information, age, gender, language preference, marital status, medical information, financial information, credit information, purchasing history information, and purchasing/shopping preferences. Purchasing/shopping preferences may include brand name preference, retailer preference, retailer location preference, etc. Personal information attributes may also include hyperlinked object viewing control (e.g., parental control) information and rules that enables a third party, such as the parent or guardian of a child viewer, to exercise control over which hyperlinked objects and associated hyperlink information are displayed for the child.

Table 2 illustrates exemplary hyperlinked object-to-user personal information attribute associations that may be maintained by the hyperdata function. In the example shown, hyperlinked objects are associated with several exemplary user personal information attributes, such as gender, age, user income, and user location. In one embodiment, user personal information attribute data that is received by the hyperdata function from a hypervideo viewer in is used to select those hyperlinked objects that are returned to the hypervideo viewer for presentation to the user. For example, hyperlinked object TS1021 is only delivered to male viewers between the ages of 7 and 12 years who live (or are viewing the video stream) in the United States.

TABLE 2
Exemplary Hyperlinked Object-to-Personal
Information Attribute Associations

| | | User Age | User Avg. | |
|---|---|---|---|---|
| Object ID | User Gender | Range | Income | User Location |
| TS1021 | Male | 7–12 yrs | * | United States |
| TS1022 | Female | * | * | Japan |
| TS1023 | * | * | * | * |

Table 3 illustrates exemplary hyperlinked object-to-hyperlink object attribute information associations that may be maintained by the hyperdata function. In the example shown, hyperlinked information or actions are associated with a hyperlinked object. Hyperlink information may include a Uniform Resource Locator (URL), a Uniform Resource Identifier (URI), an email address, an audio file or audio stream, a video file or video stream, a graphic image (e.g., JPEG file), a text message, or other hyperlink-able information. Also associated with a hyperlinked object is a hyperlink lifespan attribute, and a hyperlink appearance attribute. A hyperlink lifespan defines the amount of time that a hyperlink is to be displayed to a user. For example, when a user pauses video playback, hyperlinked object TS1021 would be retrieved from the hyperdata function and displayed to the user for 10 seconds. Once 10 seconds has elapsed, hyperlinked object TS1021 would disappear from the user's view. According to the hyperlink appearance for object TS1021, the hyperlink indicator would blink during presentation to the user. Hyperlink object characteristics such as hyperlink information (e.g., URL), hyperlink object lifespan, hyperlink object indicator color, hyperlink object appearance, and hyperlink object indicator shape are referred to herein as hyperlink object attributes.

Hyperlink information (e.g., URL) may also be associated with a hyperlink object as a function one or more personal information attributes. As illustrated in Table 3, hyperlink information is associated with hyperlink objects as a function of viewer age, viewer gender, and viewer location. For example, a hypervideo viewer that requests hyperlinked object information for a user in Atlanta, Ga. would preferentially receive hyperlinked object TS1024 with a local URL associated with an Atlanta toy store, while another hypervideo viewer that requests hyperlinked object information for a user in San Francisco would receive hyperlinked object TS1024 with a default URL associated with Amazon.com. As such, advertisements could be customized or targeted to users depending upon where they live, where they are located when viewing a hyperlinked video, or some other viewer personal information attribute.

TABLE 3
Hyperlinked Object - to - Hyperlink Object Attribute Associations

| | | | | | Hyperlinked |
|---|---|---|---|---|---|
| Object | | | | Hyperlink Information | Object |
| ID | Age | Gender | Location | (e.g.. URL, URI, etc.) | Appearance |
| TS1021 | 7 | M | * | www.amazon.com/toys/toytruck.html | Blink |
| TS1022 | 12 | F | * | www.toysrus.com/toys/doll.html | Blink |
| TS1023 | 21 | * | * | joe@travelagent.com | Static |
| | | | | | Highlight |
| TS1023 | 5 | * | * | www.toysrus.com/toys/adventure.html | Blink |
| TS1024 | * | * | * | www.amazon.com/toys/toytruck.html | Blink |
| TS1024 | * | * | Atlanta | www.atlantatoys.com/toytruck.html | Blink |
| | | | GA | | |

By using such hyperlink object associations, a hyperdata function is adapted to provide hyperlink object information that is customized to the requesting user. For example, hyperdata function may identify 15 hyperlinked objects in a particular frame of video. However, if it is determined that the user of the hypervideo viewer that originates a hyperdata query is a male between the ages of 7 and 10, only 3 of the hyperlinked objects are returned to and displayed by the requesting hypervideo viewer. Alternatively, if no user personal information attributes are specified in a received hyperdata query, all 15 of the hyperlinked objects are returned by the hyperdata function. In another example, if it is determined that the user of the hypervideo viewer that originates a hyperdata query is a male between the ages of 7 and 10, then all 15 hyperlinked objects are returned, however the hyperlink information (e.g., URL, etc.) associated with each of the hyperlinked objects is different than it would be if the viewer that originated the hyperdata query was a female between the ages of 21 and 26. In other words, both the number of hyperlink objects and the hyperlinked object attribute information returned to a requesting hypervideo viewer may vary depending upon characteristics of the user (e.g., user gender, user age, other user personal information attributes).

As mentioned previously, user personal information may also include hyperlink viewing control preference information, such as parental control information. Hyperlink viewing control preference information may be used to control the types of hyperlinked objects and/or hyperlink object attribute information that may be provided to a requesting user. For example, a parent may specify that their young children not be presented with certain types of hyperlinked objects or hyperlink information. A parent may specify that no alcohol related hyperlinked objects or hyperlink information should be presented to a user ID associated with their child. In one exemplary embodiment, a content rating indicator or content type code is associated with a hyperlinked object and/or the associated hyperlink information. For example, all hyperlinked objects related to an advertisement for alcohol may include a content type code value of “ALC”. In another example, a hyperlinked object associated with a child's toy may have a content rating value=“G”, such as illustrated in Table 4.

TABLE 4
Hyperlinked Object-to-Content Control Rating Associations

| | Content Type/ |
|---|---|
| | Rating |
| Object ID | Indicator |
| TS1021 | G |
| TS1022 | G |
| TS1023 | Y17 |

User information maintained or accessed by the hyperdata function may include allowed hyperlink content ratings for a user, such as illustrated in Table 5. Such allowed content rating rules may be enforced by the hyperdata function, such that only those hyperlinked objects and/or hyperlink actions within the allowed content rating range specified for a user may be provided to the hypervideo viewer that is serving the user when the user pauses video playback.

TABLE 5
User Content Controls Rules

| Subscriber ID/ | Allowed |
|---|---|
| User ID | Content Rating |
| John Doe | * |
| 1232122345 | G |

In an alternate embodiment, a hyperdata function is adapted to include content control rating information for each hyperlink object that is included in a hyperdata response message. In this embodiment, the hyperdata function does not maintain or enforce content viewing control rules, and instead, the hypervideo viewer is adapted to maintain content viewing control rules and enforce these rules based on the content control rating information provided by the hyperdata function.

### External Personal Information Access

It will be appreciated that personal information attributes associated with a user may be provided directly by the user in the hyperdata query message that is sent to the hyperdata function. Alternatively, at least some of the personal information associated with a hypervideo user may be obtained from other personal information services, such as personal information resellers.

According to one embodiment, a hyperdata function is adapted to receive a first hyperdata query message from a hypervideo viewer related to a viewing session by a user, and subsequently formulate a second personal information query message that requests additional information associated with the user. The second personal information query message may be sent, for example, to a reseller of personal information or to some other third party that maintains a database of personal information. The hyperdata function receives a response to the second personal information query message, and is adapted to utilize the additional personal information to determine what hyperlinked object information is to be provided to the requesting user. For example, the first hyperdata query message received from the hypervideo viewer in response to the pausing of video playback may include some user identification information (e.g., user name, email address, hypervideo service subscriber identifier, etc.) The hyperdata function may include this user identification information in a second personal information query message that requests additional personal information for the subscriber. Exemplary additional personal information provided by an external personal information database/service may include personal information attributes, as previously described.

In another embodiment of the present invention, a hyperdata function may cache user information that is either collected from users or that is obtained from third party information sources. With such an embodiment, a secondary personal information query to a third party personal information source is not required each time the first hyperdata query message is received from a hypervideo viewer in response to the pausing of a video stream during playback. In this case, at least some personal information associated with a hypervideo subscriber or user is maintained by the hyperdata function, and the personal information required to respond to a hyperdata query may be obtained without requiring a second personal information query to a third party personal information provider.

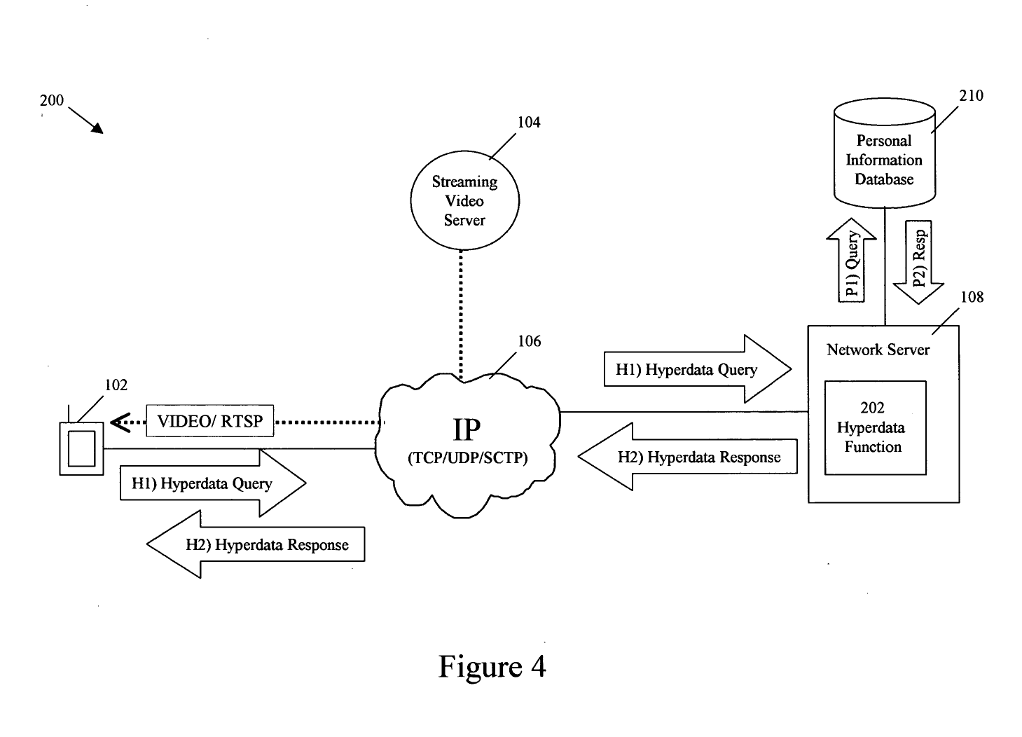

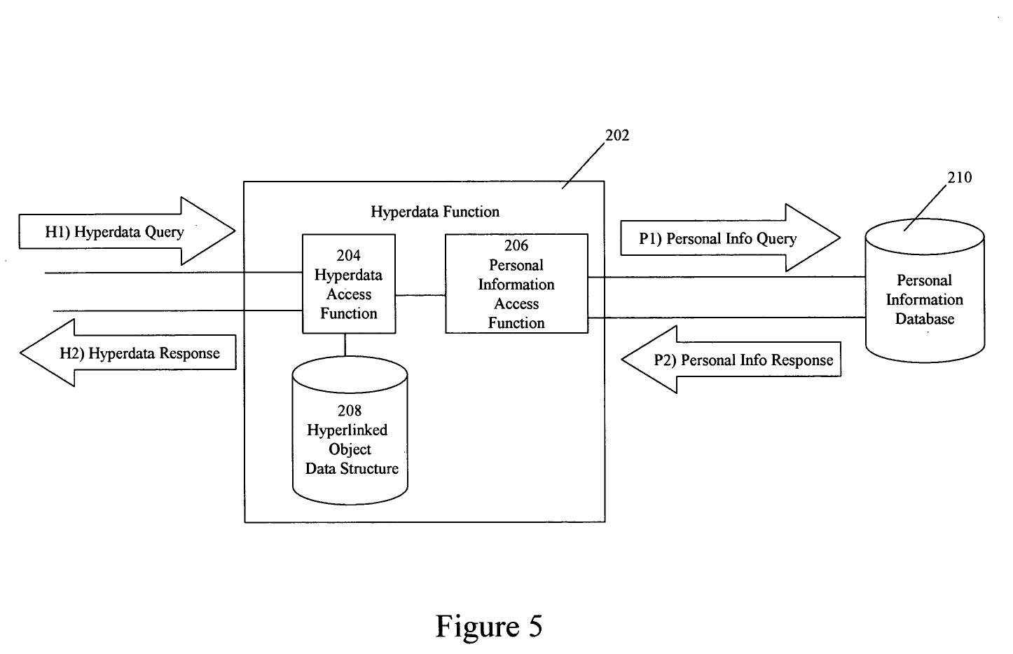

In one exemplary embodiment, illustrated in FIG. 4, a network environment 200 includes a mobile hypervideo player/viewer 102 for playing a video stream and, requesting and presenting hyperdata information, a network video server 104 for providing streaming video to viewer 102, an Internet protocol (IP) network 106 for transporting video and hyperdata information, a network hypervideo server 108 and associated hyperdata function 202 for providing hyperdata information. As further illustrated in FIG. 5, hyperdata function 202 includes a hyperdata access function 204 for receiving a hyperdata query from a hypervideo viewer. Hyperdata access function 204 is adapted to interface and communicate with a personal information access function 206, where function 206 is adapted to interface and communicate with an external personal information database/service 210.

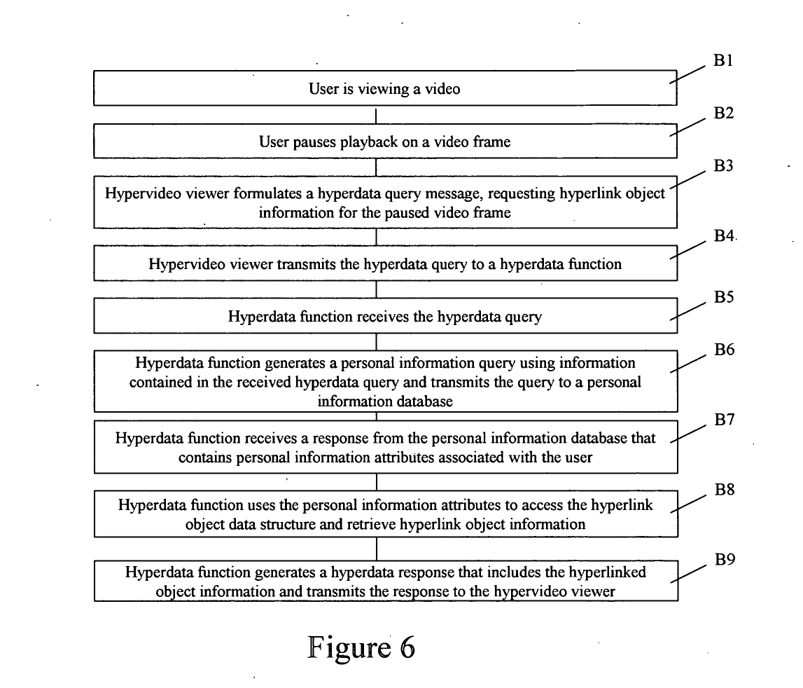

As illustrated in FIGS. 4, 5 and 6, mobile terminal 102 contacts video server 104 and begins playback of a video stream provided by the video server (step B1). When playback of the video stream is paused on mobile hypervideo player 102 (step B2), the hypervideo viewer is adapted to generate and transmit a query message (H1) to the hyperdata function 202 requesting hyperlink object information associated with the video frame on which the viewer is paused (steps B3 and B4). More specifically, hyperdata access function 204 may receive the hyperdata query (H1) that contains one or more personal information attributes (step B5). Hyperdata access function 204 is adapted to provide at least some of the personal information attributes to personal information access function 206. Function 206 is in turn adapted to generate a personal information query (P1), based on at least some of the personal information attributes, requesting additional personal information from a personal information database/service 210 (step B6). Function 206 subsequently receives a response message (P2) from the queried personal information database/service (step B7). Function 206 communicates the personal information to hyperdata access function 204, which may use at least some of the personal information returned by the personal information database/service to access hyperlink object data structure 208 and retrieve video hyperlink object information associated with the paused video frame image, where the retrieved video hyperlink object information is based at least in part on the personal information returned by the personal information database/service (step B8). The retrieved video hyperlink object information is returned by hyperdata access function 204 via response message H2 to the hypervideo viewer (step B9).

### Deployment and Operation of Hyperdata Function

In one embodiment, a hyperdata function may reside on a server in an IP network. A hypervideo viewer may act as a client and query the remote hyperdata server for hyperlinked object information, as described above. Using this type of deployment, one hyperdata server may simultaneously service multiple hypervideo viewer clients. For example, a hypervideo viewer may be adapted to view a video stream that is provided by a streaming video server in the network. When a user pauses playback of the video stream on the hypervideo viewer, the hypervideo viewer is adapted to generate a hyperdata query message and transmit the query message to the hyperdata server. The hyperdata query may contain media and personal information attributes. An exemplary hyperdata query may contain the following information: video program identification information, paused video image frame identifier, media player identifier, media playback resolution, user identification information (e.g., user name), network address of terminal hosting the media player, location of user (GPS coordinates), language preference of user.

The hyperdata function associated with the hyperdata server is adapted to process the hyperdata query using the specified media and personal information attribute information, and generate a hyperdata response message. The hyperdata response message generated by the hyperdata function includes information that specifies and defines hyperlink objects and their associated attributes that are to be presented to the user. Hyperlink object information returned by the hyperdata server is used by the querying hypervideo viewer to populate the paused video frame with hyperlinked objects that may be clicked/activated by the user.

It will be appreciated that it is an advantage of the present invention that the hypervideo viewer may receive and play streaming video from a network video server or from a local video source (e.g., DVD, local MPEG file, etc.), and still provide the hypervideo functionality described above. In one embodiment of the present invention, a video stream may be obtained/played by a hypervideo viewer from a DVD or other pre-recorded media. Since all hyperlink object-related information is maintained by the hyperdata function, the source of the video stream being played back is irrelevant. As long as the hyperdata function is provided sufficient information to identify the video program (e.g., program title, program ID) and the frame on which playback has been paused, the necessary hyperlinked object information may be provided to the requesting hypervideo viewer and accessed by the user. As such, it is an advantage of the present invention that embodiments of the hypervideo system contemplated herein are compatible with existing video servers in the network, and with pre-recorded video media such as a DVD.

In another embodiment, a hyperdata function may reside on a computing device that is local to or associated with the hypervideo viewer. For example, a hyperdata function may be located on the same PC that is running a hypervideo viewer. In one embodiment, the hyperdata function may be integrated with a hypervideo viewer to provide the hypervideo viewing functionality described herein.

### Hypervideo Viewer

According to one aspect, a hypervideo viewer of the present invention is adapted to display a video or video stream to a user, who may control playback of the video program. In response to pausing of the video playback on a video frame, the hypervideo viewer is adapted to hyperdata query a hyperdata function to obtain hyperlinked object information that is to be presented to the user while video playback is paused.

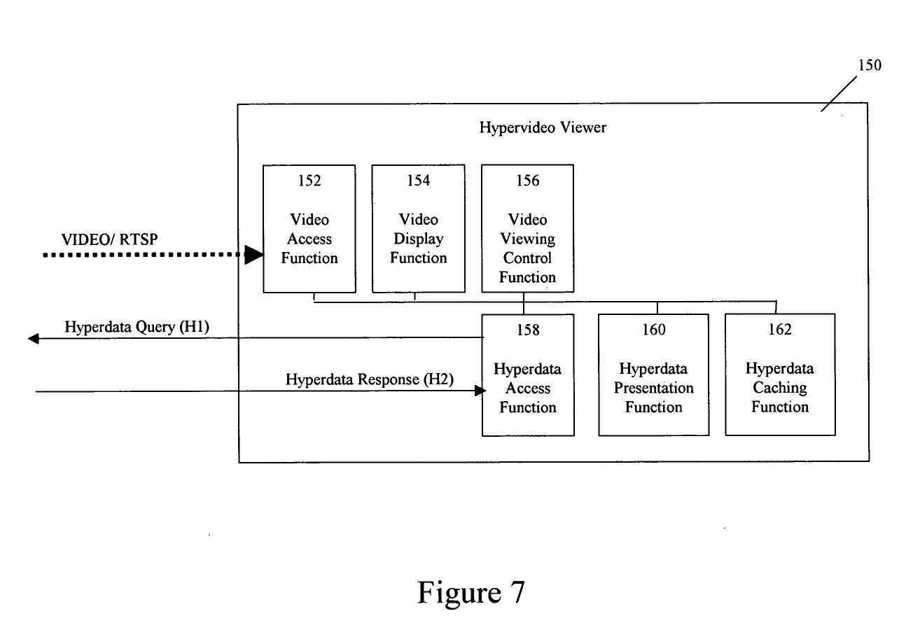

A block system diagram of an exemplary hypervideo viewer is illustrated in FIG. 7. The exemplary hypervideo viewer 150 includes a video access function 152 for receiving video information. The video access function may, for example, receive a streaming video feed from a video content server that resides in a network, or may receive video information that is retrieved from a local fixed (hard drive), or removable (DVD) storage media. Video access function 152 is adapted to provide the video to a video display function 154 that is responsible for decoding, formatting, and presenting the video image to a user. A video control function 156 enables a user to control various aspects of video playback, including pausing playback of the video. Pausing of video playback is used by a hyperdata access function 158 to trigger the retrieval of hyperlink object information from a hyperdata function. In one embodiment, hyperdata access 158 function is adapted to register and/or authenticate a requesting user prior to accessing the requested hyperlinked object information. In response to pausing playback of the video media, the hyperdata access function is adapted to formulate a hyperdata query message (H1) requesting hyperlinked object information for the video image frame on which playback has been paused. The hyperdata query message is communicated to a hyperdata function located on a network server. The network hyperdata function responds with a hyperdata response message (H2). The hyperdata response message containing the requested hyperlinked object information is received by the hyperdata access function 158 and the provided to a hyperdata presentation function 160. The hyperdata presentation function is adapted to present/display the received hyperlinked object information to the user and provide access to the object hyperlinks.

In one embodiment, the hyperdata presentation function may translate or convert received hyperlinked object screen position/location coordinates to account for the current viewing aspect ratio/screen size. The hyperdata presentation function is adapted to hide or remove the presented hyperlinked objects from display to the user when playback of the video is resumed. In one embodiment, hyperdata presentation function 160 is adapted to enforce content control rule information (e.g., parental control rule information) that is received from a network hyperdata function, such as the content control information previously described in this disclosure.

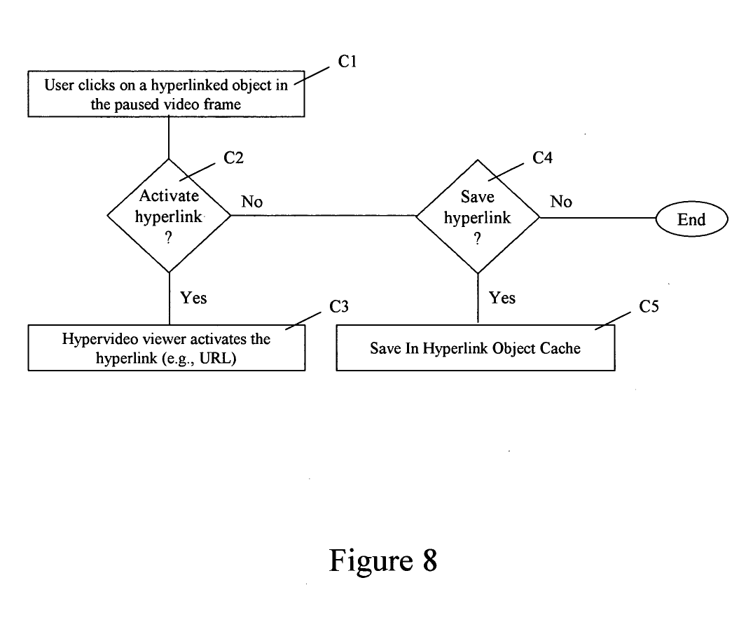

In one embodiment, a hyperdata caching function 162 is adapted to cache previously retrieved hyperlinked object information once playback of the video is resumed. The caching function enables a user to view previously retrieved hyperlinked object data at any point during video playback. In one embodiment, a user is allowed to select and save a particular hyperlink object for later viewing/interaction. In this case, a hypervideo viewer may cache the user selected hyperlink object for later viewing/interaction. An exemplary process diagram illustrating a hyperlink data-caching embodiment is presented in FIG. 8. In step C1, following the acquisition of hyperlink object data during a pause in video playback as described previously, the user of a hypervideo viewer selects/clicks on a hyperlink object that is presented on the hypervideo viewer display. The user is then given the option to activate/execute the hyperlink (step C2). If the user chooses, the hyperlink may be activated/executed (step C3), or alternatively the user may choose to cache the hyperlink (step C4) in which case the hyperlink is saved for later use/access (step C5).

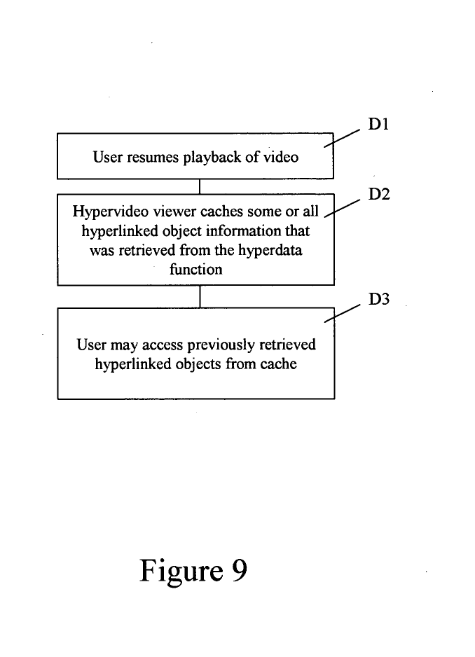

In an alternate embodiment, the hypervideo caching function 162 is adapted to cache some or all hyperlink object information associated with a paused video frame image once playback of the video is resumed. An exemplary process diagram illustrating this hyperlink data-caching embodiment is presented in FIG. 9. In step D1, following the acquisition of hyperlink object data during a pause in video playback as described previously, playback of the video is resumed. The hyperlink object data associated with a paused video frame image is cached once playback is resumed (step D2) and may be accessed at some point following the resumption of video playback (step D3).

The hypervideo viewer is adapted to receive the video hyperlink object/attribute information for the paused video frame that is currently being viewed, and incorporate the video hyperlink data into the paused video frame, so as to make the hyperlink objects specified in the hyperdata response message accessible in the paused video frame with a pointing device (e.g., computer mouse, light pen, touch screen, keyboard). The hypervideo viewer may use the returned screen position or screen location information provided for a hyperlinked object within the paused video frame to identify the “clickable” region of the viewing screen that is associated with the hyperlinked object. For example, the hypervideo viewer may use the positional or location information provided for a hyperlinked object to highlight the object when the user moves a pointer (e.g., mouse, light pen, touch screen) over the object. In any event, the returned positional or location information provided for a hyperlinked object is used by the hypervideo viewer both to determine where on the display screen to place a hyperlink object indicator and to determine when a user has selected or clicked on a hyperlinked object that is present or defined within a paused video frame.

Once all hyperlinked object information associated with a paused video frame has been obtained from the hyperdata function, the user may select or “click” on a hyperlinked object that is displayed in the paused video frame. Hyperlink objects may be constantly displayed, or a hyperlink object may only be displayed when the user moves a pointing device over the appropriate area of the screen. Once again, in one embodiment, the hypervideo viewer may use the provided hyperlinked object screen position or screen location information to highlight “clickable” objects in the paused video frame. In response to moving a pointing device over a hyperlinked object, object attribute information returned by the hyperdata function may be displayed. For example, when a user moves a pointer over a hyperlinked object, a pop-up dialog box may appear on the screen which contains an advertisement/information associated with the hyperlinked object.

In response to the clicking of a hyperlinked object in the paused video frame, the video viewer may perform a hyperlink action. Exemplary hyperlink actions include, but are not limited to, opening or displaying a WEB browser to display a URL, executing an applet, displaying a graphic image (e.g., JPEG image), displaying a text dialog box, opening a media player to play a video clip (e.g., MPEG, AVI, Quicktime), opening a media player to play audio (e.g., MP3, WAV), initiating a purchase transaction (e.g., credit card transaction), opening an email client, opening a text or multimedia messaging client, opening a voice over IP communications client and initiating a voice call, or any other action associated with the hyperlink obtained from the hyperdata function.

According to one aspect of the present invention, a hyperdata query message generated by the hypervideo viewer in response to the pausing of video playback may contain media and personal information attributes, such as video program identification information, paused video image frame identifier, media player identifier, media playback resolution, user identification information (e.g., user name), network address of terminal hosting the media player, location of user (GPS coordinates), language preference of user.

Information that identifies the user may include, but is not limited to, a name, an electronic mail (email) address, a screen name, a hypervideo service subscriber identifier or other personal identifier. Hypervideo media attributes provided to the hyperdata function may include, but are not limited to, a viewer name identifier attribute (e.g., Windows Media Player, Real Player, etc.), a viewer screen size attribute (e.g., aspect ratio, widescreen, full screen, etc.), a viewer media capabilities attribute (e.g., video codec: MPEG-x, AVI, WMV, ASF, ASX, DivX, MOV, audio codec: MP3, WAV, AC3, AAC, etc.), and a viewer color/BW display capability attribute. Information that identifies the video program being viewed may include, but is not limited to, a program name identifier. Information that identifies the frame on which the viewer is paused may include, but is not limited to, a frame identifier, and a playback time offset identifier (e.g., elapsed playing time). Information that identifies attributes of the user that is viewing the video may include, but is not limited to, name, gender, age, income level information, marital status, viewing habit information, buying preference information, geographic location, language preference, nationality, home address (e.g., street address, city, state, zip code), and telephone number. Once again, this information may be used to determine which hyperlinked objects are displayed to the user, and/or the hyperlink action associated with a hyperlinked object that is presented to a user. For example, a female user may be presented with a set of hyperlinked objects on a paused video frame, while a male user may be presented with a different set of hyperlinked objects while paused on the same video frame. In the same manner, a user with a Japanese language preference may be presented with a Japanese language advertisement when paused on a video frame, while a user with a French language preference may be presented with a French language advertisement when paused on the same video frame.

Exemplary protocols that may be used to formulate and communicate a hyperdata query message generated by the hypervideo viewer to the hyperdata function include, but are not limited to, Internet protocol (IP), TCP, UDP, SCTP, HTML, XML, SOAP, and FTP. A proprietary protocol or protocols may also be used to facilitate communication between a hypervideo viewer and a hyperdata function.

It will be appreciated that an advantage of the present invention over previously disclosed hypervideo delivery systems is that hyperlinked object information is provided to a hypervideo viewer/user in an “on-demand” manner. That is, additional bandwidth is required to transport hyperlinked object related data only when a user pauses video playback, and even then only hyperlinked object information associated with the paused video frame need be provided to the hypervideo viewer for display to a user. As such, the present invention may be extremely useful in wireless networking environment, where bandwidth resources are limited.

Another advantage of the present invention is the ability of the disclosed hypervideo delivery system to provide a user with customized hyperlink object data, depending on personal information attribute information that is ether provided by the user/the user's hypervideo viewer or is obtained from a third party personal information database. Also, the present invention allows a hypervideo viewer to provide a user with hyperlink object data regardless of the source of the video media they are viewing. That is, a hypervideo viewer of the present invention does not require a specially encoded/processed video stream in order to provide hypervideo content to a user. The hypervideo viewer is adapted to play a conventionally formatted (e.g., MPEG, AVI, WMV) video from any source, and to query a hyperdata function to obtain hyperlinked object information for any video frame in a video stream

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A system for viewing hyperlinked video, the system comprising:
(a) A video stream comprising a sequence of video frame images;
(b) A hypervideo viewer for;
(i) Playing the video stream;
(ii) Pausing the playing of the video stream on a video frame image;
(iii) Requesting hyperlink object information for the paused video frame image;
(iv) Receiving hyperlink object information; and
(v) Presenting the hyperlink object information.

2. The system of claim 1 wherein requesting hyperlink object information includes querying a hyperdata function.

3. The system of claim 1 where receiving hyperlink object information includes receiving hyperlink object attribute information from a hyperdata function.

4. The system of claim 1 wherein presenting the hyperlink object information includes displaying the hyperlink object information on the paused video frame image.

5. The system of claim 1 including a caching function for caching at least a portion of the received hyperlink object information.

6. A hypervideo viewer, the hypervideo viewer comprising:
(a) A video playback function for playing a video stream that is comprised of a sequence of video frame images;
(b) A hyperdata access function for, in response to pausing playback of the video stream on a video frame image;
(i) Generating a hyperdata query message associated with the video frame image;
(ii) Sending the hyperdata query message to a hyperdata function requesting information associated with hyperlinked objects that are defined on the video frame image; and
(iii) Receiving a response to the hyperdata query message from the hyperdata function that includes hyperlink object information associated with a hyperlinked object that is defined on the video frame image.
(c) A hyperlinked object presentation function for applying the hyperlinked object information to the video frame image and providing access to the hyperlinked object.

7. The hypervideo viewer of claim 6 where generating a hyperdata query message includes generating a hyperdata query message that includes media attributes.

8. The hypervideo viewer of claim 6 where generating a hyperdata query message includes generating a hyperdata query message that includes personal information attributes associated with a user.

9. The hypervideo viewer of claim 6 wherein providing access to the hyperlinked object includes performing a hyperlink action in response to selection of the hyperlinked object by a user.

10. The hypervideo viewer of claim 6 including a caching function for caching at least a portion of the received hyperlink object information.

11. The hypervideo viewer of claim 6 wherein receiving a response to the hyperdata query message from the hyperdata function includes receiving a response that includes content control rating information.

12. The hypervideo viewer of claim 11 including a viewing control rules function for maintaining and enforcing content viewing control rules based on the received content control rating information.

13. A hyperdata function, the hyperdata function comprising:
(a) A data structure that includes hyperlink object information associated with hyperlinked objects that are defined within a video frame image;
(b) A hyperdata application for;
(i) Receiving a hyperdata query message requesting hyperlink object information associated with hyperlinked objects that are defined within a paused video frame image;
(ii) Using information contained in the hyperdata query message to access hyperlinked object information in the data structure and obtain hyperlink object information associated with hyperlink objects that are defined within the paused video frame image; and
(iii) Generating a hyperdata response message, which includes the hyperlink object information.

14. The hyperdata function of claim 13 wherein the data structure associates hyperlinked object, hyperlink information, and personal information attributes.

15. The hyperdata function of claim 13 wherein receiving a hyperdata query message requesting hyperlink object information associated with hyperlinked objects that are defined within a video frame image includes receiving a hyperdata query message that includes a media attribute.

16. The hyperdata function of claim 13 wherein receiving a hyperdata query message requesting hyperlink object information associated with hyperlinked objects that are defined within a video frame image includes receiving a hyperdata query message that includes a personal information attribute.

17. The hyperdata function of claim 13 wherein generating a hyperdata response message includes generating a response message which includes hyperlink object information that is dependent on a personal information attribute.

18. The hyperdata function of claim 13 wherein the hyperdata application is adapted to query a personal information database to retrieve personal information associated with a user.

19. The hyperdata function of claim 18 where the retrieved personal information is used to obtain hyperlink object information associated with hyperlinked objects that are defined within a video frame image.

20. The hyperdata function of claim 18 including a caching function for caching at least a portion of the received personal information.

21. The hyperdata function of claim 13 wherein the data structure includes viewing control rules.

22. The hyperdata function of claim 21 wherein the hyperdata function is adapted to enforce the viewing control rules.

23. A method for obtaining hyperlink object information associated with a video, the method comprising:
(a) In response to pausing the playback of a video on a video image frame;
(i) Querying a hyperdata function to obtain hyperlink object information associated with hyperlinked objects that are defined within the video frame image; and
(ii) Receiving from the hyperdata function a response message, which includes hyperlink object information associated with hyperlinked objects that are defined within the video frame image.

24. The method of claim 23 wherein querying a hyperdata function includes providing the hyperdata function with media attributes.

25. The method of claim 23 wherein querying a hyperdata function includes providing the hyperdata function with personal information attributes.

26. The method of claim 23 including querying a personal information database to obtain personal information attributes that may be used by the hyperdata function to obtain hyperlink object information associated with hyperlinked objects that are defined within the video frame image.

27. The method of claim 26 including caching the personal information attributes.

28. The method of claim 23 including caching at least some of the received hyperlink object information associated with hyperlinked objects that are defined within the video frame image.

29. The method of claim 28 where caching at least some of the received hyperlink object information associated with hyperlinked objects that are defined within the video frame image includes caching hyperlink object information associated with hyperlink objects that are selected by a user.

30. The method of claim 28 where the cached hyperlink object information may be accessed by a user after playback of the video has been resumed.

31. A computer program product comprising computer executable instructions embodied in a computer readable medium for performing steps comprising:
(a) In response to pausing the playback of a video on a video image frame;
(i) Querying a hyperdata function to obtain hyperlink object information associated with hyperlinked objects that are defined within the video frame image; and
(ii) Receiving from the hyperdata function a response message, which includes hyperlink object information associated with hyperlinked objects that are defined within the video frame image.

32. The computer program product of claim 31 wherein querying a hyperdata function includes providing the hyperdata function with media attributes.

33. The computer program product of claim 31 wherein querying a hyperdata function includes providing the hyperdata function with personal information attributes.

34. The computer program product of claim 31 including querying a personal information database to obtain personal information attributes that may be used by the hyperdata function to obtain hyperlink object information associated with hyperlinked objects that are defined within the video frame image.

35. The computer program product of claim 34 including caching the personal information attributes.

36. The computer program product of claim 31 including caching at least some of the received hyperlink object information associated with hyperlinked objects that are defined within the video frame image.

37. The computer program product of claim 36 where caching at least some of the received hyperlink object information associated with hyperlinked objects that are defined within the video frame image includes caching hyperlink object information associated with hyperlink objects that are selected by a user.

38. The computer program product of claim 36 where the cached hyperlink object information may be accessed by a user after playback of the video has been resumed.
